(19) United States
(12) Patent Application Publication
(10) Pub. No.: US 2011/0185926 A1
(43) Pub. Date: Aug. 4, 2011

(54) VIBRATOR ASSEMBLY FOR AN INKING UNIT OR A DAMPENING UNIT OF A PRINTING PRESS

(75) Inventors: Ken Francis Blaney, Middleton, NH (US); Michael Robert Lemelin, Madbury, NH (US)

(73) Assignee: Gross International Americas, Inc., Durham, NH (US)

(21) Appl. No.: 12/698,805

(22) Filed: Feb. 2, 2010

(51) Int. Cl. B41F 7/02; B41F 33/00

(52) U.S. Cl. 101/217; 101/352.06; 101/483

(57) ABSTRACT

An offset printing press is provided including a plate cylinder and a fluid dispersing unit dispersing fluid to the plate cylinder. The fluid dispersing unit includes a vibrator roll, a shaft supporting the vibrator roll and a motor including a coil and a magnet. The coil is disposed about the magnet and the magnet or the coil is mounted on the shaft. The motor oscillates the vibrator roll axially. A vibrating assembly for a fluid dispersing unit of a printing press is also provided.

The present invention relates to printing presses and more particularly to a vibrator assembly for an inking unit or a dampening unit of a printing press.

### BACKGROUND OF THE INVENTION

U.S. Pat. No. 3,994,222 discloses a vibrator mechanism for axially reciprocating the ink drums of a rotary printing press inking mechanism in predetermined phase relationship consists of coacting inner and outer eccentrics that are telescoped over each other and over a common drive shaft. The inner eccentric is releasably connected to the drive shaft so that it can be adjusted angularly about the drive shaft relative to the outer eccentric from a remote, conveniently accessible position to thereby vary the amplitude of the reciprocating motion imparted to the ink drums and the outer eccentric is connected to the drive shaft for positive rotation therewith by means which permit it to shift angularly and radially relative to the drive shaft to accommodate the angular adjustments of the inner eccentric.

U.S. Pat. No. 5,309,833 discloses a printing apparatus that includes a plurality of ink distributor rolls supported for rotation about their axes, a rotatable shaft, and a vibrating means for reciprocating the rolls axially in response to rotation of the shaft. The vibrating means comprises a plurality of eccentric members fixed to the shaft for rotation with the shaft. Each of the eccentric members applies an individual torque to the shaft in response to axial movement of a respective one of the rolls when the eccentric member rotates with the shaft.

U.S. Pat. No. 5,794,529 discloses a plate cylinder gear connected to the input of a compliant drive. An output of the compliant drive is connected to a vibrator mechanism, specifically an ink vibrator and a water vibrator. The compliant drive includes an input gear, driven by the plate cylinder gear. The input gear is connected, through a compliant connection allowing compliant transmission of torque, to at least one output gear. A first output gear can be coupled through a compliant connection to the input gear, and a second output gear, can be coupled through a clutch to the first output gear. The first output gear is coupled to, and drives, a gear for the water vibrator, and the second output gear is coupled to, and drives, a gear for the ink vibrator.

### SUMMARY OF THE INVENTION

An offset printing press is provided including a plate cylinder and a fluid dispersing unit dispersing fluid to the plate cylinder. The fluid dispersing unit includes a vibrator roll, a shaft supporting the vibrator roll and a motor including a coil and a magnet. The coil is disposed about the magnet and the magnet or the coil is mounted on the shaft. The motor oscillates the vibrator roll axially.

An offset printing press includes a plate cylinder and a fluid dispersing unit dispersing fluid to the plate cylinder that includes a vibrator roll and a linear servomotor oscillating the vibrator roll is also provided.

A vibrating assembly for a fluid dispersing unit of a printing press is provided. The vibrating assembly includes a vibrator roll, a shaft supporting the vibrator roll and a motor including a coil and a magnet. The coil is disposed about the magnet and the magnet or the coil is mounted on the shaft. The motor oscillates the vibrator roll axially with respect to the shaft.

A method of optimizing a vibrating assembly of a printing press is also provided. The method includes providing data of an image to be printed during a print job by the printing press to a computer; and determining an optimal stroke rate and stroke frequency of the vibrating assembly for the printing job based on the data.

### BRIEF DESCRIPTION OF THE DRAWINGS

The present invention is described below by reference to the following drawings, in which:

FIG. 1 shows an offset printing press according to an embodiment of the present invention;

FIG. 2 shows a cross-sectional side view of a vibrating assembly of an inking unit in a printing press according to an embodiment of the present invention; and

FIG. 3 shows a cross-sectional side view of a vibrating assembly of an inking unit in a printing press according to another embodiment of the present invention.

### DETAILED DESCRIPTION OF THE PREFERRED EMBODIMENTS

Printing units may experience side frame vibration during the printing process. One of the causes of such side frame vibration may be vibrator rolls, which may move laterally so as to provide a more consistent ink coating or dampening solution to a plate cylinder. Some of the vibrations may reduce the operating life of printing press equipment and also may cause print doubling on the printed material, leading to poor print quality and paper waste.

In some prior devices, vibrator oscillation may cause torque disturbances due to vibrations being fed back through the printing unit drive and printing unit cylinders. Printing unit frames may also be vibrated. In order to minimize friction and wear of mechanical elements in the printing unit drive, larger drive motors have been employed. The use of mechanical elements in a printing unit drive can complicate vibrator stroke variation and may cause printing unit frame vibration, which may lead to print doubling.

Attempts to minimize effects of vibrator rolls have included: placing a common shaft between vibrators to help minimize the total torque disturbance, using bearings in place of a sliding block in a commercial vibrator mechanism to minimize print doubling on the printed material, phasing the vibrator roll to minimize frame vibration or using a compliant drive and uniflank mechanism to minimize the torque disturbance transmission back to the plate cylinder.

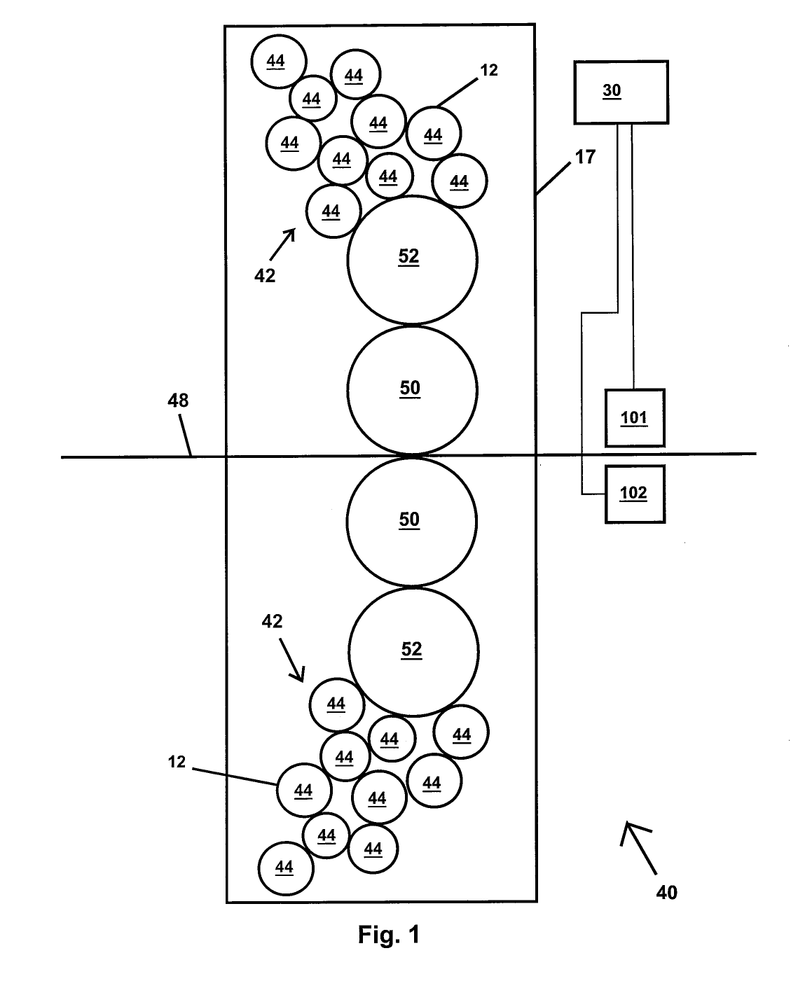

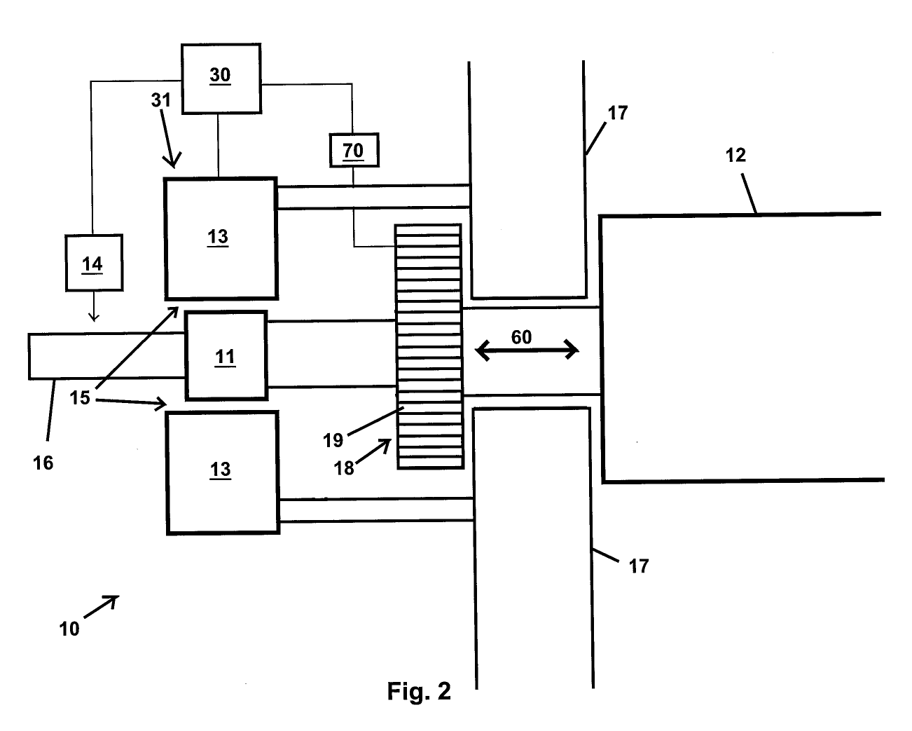

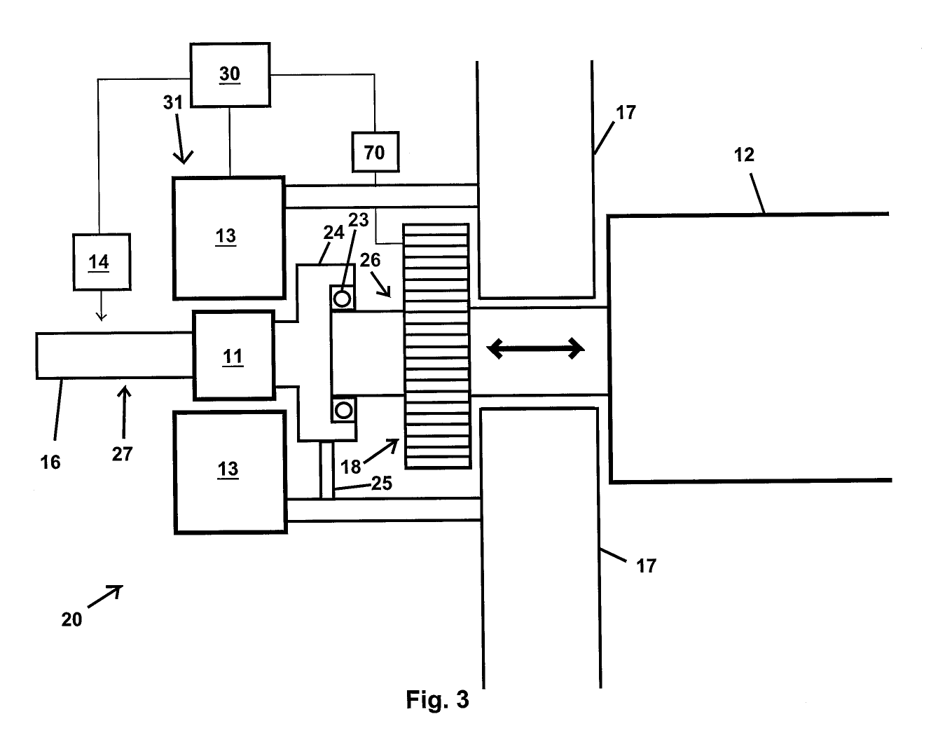

FIG. 1 shows an offset printing press 40 according to an embodiment of the present invention. Printing press 40 includes dampening units 43 dispersing dampening fluid to plate cylinders 52 and inking units 42 dispersing ink to plate cylinders 52. Plate cylinders 52 transfer inked images to blanket cylinders 50, which print the images on a web 48. Inking units 42 may include a number of rolls 44 and dampening units 43 may include a number of rolls 54. To facilitate uniform transfer of ink from inking units 42 and dampening fluid from dampening units 43 to plate cylinders 52, one or more ink rolls 44 or dampening rolls 54 may be a vibrator roll 12 as further described in relation to FIGS. 2 and 3. Vibrator rolls 12 may oscillate back and forth in an axial direction to aid uniform dispersion of ink and dampening solution to plate cylinders 52. Ink rolls 44 and dampening rolls 54 that are vibrator rolls 12 may be oscillated by vibrating assemblies 10, 20 shown in FIGS. 2 and 3, respectively. The oscillation of vibrator rolls 12 may controlled by at least one controller 30, which may be coupled to one or more print quality measuring devices 101, 102 for measuring print quality of web 48 downstream of printing press 40.

FIG. 2 shows a cross-sectional side view of a vibrating assembly 10 of a fluid dispersing unit, such as an inking unit or a dampening unit, in a printing press according to an embodiment of the present invention. Vibrating assembly 10 includes a linear servomotor 31 which includes a magnet 11 and a coil 13 surrounding magnet 11. Current flowing through coil 13 may cause magnet 11 to oscillate in an axial direction 60. Vibrator roll 12 may for example be an ink transfer roll or a dampening roll. Vibrator roll 12 may oscillate independently of other vibrator rolls in the printing press, which may contribute to simplicity of mechanical design and operation of the printing press.

In a preferred embodiment, magnet 11 is attached to a shaft 16 supporting vibrator roll 12 and coil 13 is positioned in a fixed location around magnet 11 and attached to a frame 17 of vibrating assembly 10. In an alternative embodiment, coil 13 is attached to shaft 16 and magnet 11 is positioned in a fixed location and attached to frame 17, with magnet 11 oscillating coil 13. A gap 15 may exist between coil 13 and magnet 11. Specifically, coil 13, by interacting with magnet 11, may non-contactingly drive and oscillate vibrator roll 12 by axially reciprocating vibrator roll 12 in an oscillating motion to facilitate uniform ink distribution in the printing press. The configuration of vibrating assembly 10 may help minimize the amount of torque and vibrations that are fed back to a main drive motor, which may be rotating inkers and cylinders of the printing press. This may help reduce or eliminate print doubling. Also, smaller main drive motors may be used.

A linear encoder 14 may measure an axial position of vibrator roll 12 via at least one sensor and send a feedback signal to a controller 30, which may be a computer. Linear encoder 14 may sense the position of vibrator roll 12, shaft 16, magnet 11 or any other part of vibrating assembly 10 that allows linear encoder 14 to measure the axial position of vibrator roll 12. Controller 30, based on desired printing parameters and feedback from linear encoder 14, controls the stroke rate and frequency of the oscillation of vibrator roll 12 by coil 13 and magnet 11. Controller 30 may be programmable with default parameters or specific parameters required for a particular print job. Vibrating assemblies 10, 20 may be optimized on a job by job basis by changing vibrator stroke rate and frequency via controller 30 and/or encoder 14, for example, to obtain better print quality. Job by job print performance optimization may be achieved by coupling controller 30 to one or more print quality measuring devices 101, 102 (FIG. 1) for on the run optimization. Controller 30, via a human operator or based on an algorithm, may vary the operation of servomotor 31 and drive motor 70 based on print quality determinations made by print quality measuring devices 101, 102 (FIG. 1) and may increase or decrease vibrator stroke rate and frequency to optimize print quality. The ability of vibrating assembly 10 to vary the vibrator stroke length and frequency via controller 30, as opposed to mechanically, may advantageously allow the vibrator stroke length and frequency to be varied job to job and customer to customer.

Linear encoder 14 ensures that the axial positioning of vibrator roll 12 is as desired and allows controller 30 to adjust the axial positioning of vibrator roll 12 if necessary via control of coil 13. Linear encoder 14 may be integrated into linear servomotor 31, but may be separate as well.

Controller 30 allows an operator to input or program the manner in which vibrator roll 12 is oscillated. A length of reciprocations or strokes of vibrator roll 12 may be set to provide particular vibration characteristics for vibrator assembly 10. Also, the operator may phase vibrator roll 12 via controller 30 with other vibrator rolls that may be present in the printing press to further minimize frame 17 vibrations.

In one embodiment, a drive gear 18 rotates vibrator roll 12. A drive motor 70 may rotate drive gear 18. Drive motor 70 may be a main drive motor that also rotates cylinders and other rolls in the printing press. Drive gear 18 includes engageable gear teeth 19 that may engage other gears used in printing press operation. In one embodiment, drive motor 70 may be controlled by controller 30.

In another embodiment, servomotor 31 may be configured so that servomotor 31 rotates vibrator roll 12 in addition to axially oscillating vibrator roll 12.

FIG. 3 shows a cross-sectional side view of a vibrating assembly 20 of an inking unit in a printing press according to another embodiment of the present invention. Vibrating assembly 20 includes magnet 11, coil 13, linear encoder 14, controller 30, drive gear 18 and frame 17. Vibrating assembly 20 is configured in the same manner as vibrating assembly 10 shown in FIG. 2, except that vibrating assembly 20 includes a bearing 23 enclosed in a housing 24, which may be attached to frame 17 of vibrating assembly 20. Bearing 23 may be included to isolate the rotation of vibrator roll 12, allowing a roll side portion 26 of shaft 16 to rotate independently of a remainder portion 27 of shaft 16. Housing 24 may be attached to a ground 25 to limit voltage build up in the vibrating assembly 20.

Oscillating roll 12 and magnet 11 may advantageously minimize the amount of mass that oscillates, compared with mechanical setups, and frame vibration may be advantageously reduced. The non-contacting nature of magnet 11 and coil 13 may help prevent friction or mechanical wear.

Vibrating assemblies 10, 20 may also be used in a variable cutoff web offset printing press.

Vibrating assemblies 10, 20 may eliminate uniflank mechanisms and/or compliant drives used to minimize the torque disturbance transmission back to plate cylinders. Also, a printing press equipped with either of vibrating assemblies 10, 20 may be run at higher speeds due to minimization of vibrations.

A further advantage of the present invention includes optimizing press jobs using a simulation model that creates a predicted printed image. For each individual print job printed by printing press 40 (FIG. 1) a stroke rate and stroke frequency of vibrator roll 12 may be set specifically for the print job before printing begins based on one or more attributes of the print job, for example, ink density, lateral starvation, and the size of the images being printed. Images to be printed during the print job are scanned and provided to a computer that includes a simulation model. The computer may be included in controller 30 or may be in communication with controller 30. The simulation model produces a predicted printed image for the print job based on ink performance, including, for example, inker design, ink density, lateral starvation and splitting and displays the predicted printed image to a press operator. The press operator reviews the predicted printed image and may vary the stroke rate and stroke frequency of vibrator roll 12 as needed until a desired predicted printed image is obtained from the simulation model. The stroke rate and stroke frequency are then fixed for the specific print job. Thus, the press operator may accept settings for the stroke rate and stroke frequency or alter the results manually to optimize printing performance for each print job based on the predicted printed image obtained from the simulation model. The stroke rate and stroke frequency data may be stored and used again for the same or similar print jobs. Controller 30 may then direct the operation of vibrating assembly 20 during each print job based on the optimized values determined for the stroke rate and stroke frequency.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. An offset printing press comprising:
a plate cylinder; and
a fluid dispersing unit dispersing fluid to the plate cylinder, the fluid dispersing unit including a vibrator roll, a shaft supporting the vibrator roll and a motor including a coil and a magnet, the coil being disposed about the magnet and the magnet or the coil being mounted on the shaft, the motor oscillating the vibrator roll axially.

2. The printing press recited in claim 1 further comprising a frame, the magnet or the coil not mounted on the shaft being mounted on the frame.

3. The printing press recited in claim 1 further comprising a linear encoder measuring an axial position of the vibrator roll, the motor being a servomotor.

4. The printing press recited in claim 3 further comprising a controller, the controller receiving feedback from the linear encoder and controlling the servomotor.

5. The printing press recited in claim 4 further comprising at least one print quality measuring device for measuring downstream print quality coupled to the controller, the controller being adapted to control the servomotor based on measured downstream print quality.

6. The printing press recited in claim 1 further comprising a bearing connected to the shaft, the bearing isolating a roll side portion of the shaft from a remainder portion of the shaft so that the roll side portion can be rotated independently of the remainder portion.

7. The printing press recited in claim 1 wherein the coil oscillates the magnet axially with respect to the shaft to oscillate the vibrator roll.

8. The printing press as recited in claim 1 further comprising a second vibrator roll, the vibrator roll being oscillated independently of the second vibrator roll.

9. The printing press as recited in claim 1 further comprising a drive gear rotating the vibrator roll.

10. The printing press as recited in claim 9 further comprising a drive motor rotating the drive gear.

11. The printing press as recited in claim 1 further comprising a blanket cylinder contacting the plate cylinder.

12. An offset printing press comprising:
a plate cylinder; and
a fluid dispersing unit dispersing fluid to the plate cylinder including a vibrator roll and a linear servomotor oscillating the vibrator roll.

13. The printing press recited in claim 12 further comprising a linear encoder measuring the axial position of the vibrator roll.

14. The printing press recited in claim 13 further comprising a controller, the controller receiving feedback from the linear encoder and controlling the servomotor to vary the stroke length and frequency of the vibrator roll.

15. The printing press recited in claim 14 further comprising at least one print quality measuring device for measuring downstream print quality coupled to the controller, the controller being adapted to control the servomotor based on measured downstream print quality.

16. The printing press as recited in claim 12 further comprising a blanket cylinder contacting the plate cylinder.

17. A vibrating assembly for a fluid dispersing unit of a printing press comprising:
a vibrator roll;
a shaft supporting the vibrator roll; and
a motor including a coil and a magnet, the coil being disposed about the magnet and the magnet or the coil being mounted on the shaft, the motor oscillating the vibrator roll axially.

18. The vibrating assembly recited in claim 17 further comprising a frame, the magnet or the coil not mounted on the shaft being mounted on the frame.

19. The vibrating assembly recited in claim 17 further comprising a linear encoder measuring an axial position of the vibrator roll, the motor being a servomotor.

20. The vibrating assembly recited in claim 19 further comprising a controller, the controller receiving feedback from the linear encoder and controlling the servomotor to vary the stroke length and frequency of the vibrator roll.

21. The vibrating assembly recited in claim 17 further comprising a bearing connected to the shaft, the bearing isolating a roll side portion of the shaft from a remainder portion of the shaft so that the roll side portion can be rotated independently of the remainder portion.

22. The vibrating assembly recited in claim 17 wherein the coil oscillates the magnet axially with respect to the shaft to oscillate the vibrator roll.

23. A method of optimizing a vibrating assembly of a printing press comprising:
providing data of an image to be printed during a print job by the printing press to a computer; and
determining an optimal stroke rate and stroke frequency of the vibrating assembly for the printing job based on the data.

24. The method recited in claim 23 further comprising:
operating the vibrating assembly based on the determined optimal stroke rate and stroke frequency for the print job.

25. The method recited in claim 23 wherein the providing step includes scanning the image into the computer.

26. The method recited in claim 23 wherein the determining step includes processing the data with the computer and displaying a predicted printed image on the computer based on a stroke rate setting and a stroke length setting.

27. The method recited in claim 26 wherein the determining step further includes varying the stroke rate setting and the stroke length setting based on the predicted printed image.
